(19) United States
(12) Patent Application Publication
(10) Pub. No.: US 2025/0292959 A1
(43) Pub. Date: Sep. 18, 2025

(54) MULTILAYER CERAMIC CAPACITOR AND CIRCUIT BOARD

(71) Applicant: TAIYO YUDEN CO., LTD., Tokyo (JP)

(72) Inventors: Tomoki INOUE, Tokyo (JP); Yoshinari TAKE, Tokyo (JP); Takayuki TAKANO, Tokyo (JP); Takeshi SAKASHITA, Tokyo (JP); Ryo NAKAGAWA, Tokyo (JP); Yuka NAITO, Tokyo (JP)

(73) Assignee: TAIYO YUDEN CO., LTD., Tokyo (JP)

(21) Appl. No.: 19/075,620

(22) Filed: Mar. 10, 2025

(30) Foreign Application Priority Data
Mar. 12, 2024 (JP) 2024-038072

(51) Int. Cl. H01G 2/06; H01G 4/008; H01G 4/12; H01G 4/232; H01G 4/236; H01G 4/30

(52) U.S. Cl. CPC H01G 2/06; H01G 4/008; H01G 4/12; H01G 4/232; H01G 4/236; H01G 4/30

(57) ABSTRACT

One aspect of the present invention is a multilayer ceramic capacitor, including: a cuboid element body having a stack formed with alternating ceramic layers and internal electrodes made primarily of metal and a protective portion covering a surface of the stack, and a plurality of terminal electrodes arranged on at least a mounting face, which is the face that faces the circuit board when the multilayer ceramic capacitor is mounted on the circuit board, among faces that form the surfaces of the element body, the mounting face being the face opposing the circuit board during circuit board mounting, and connected electrically to the internal electrodes, wherein the mounting face has a sloped portion in the vicinity of the end portion of each terminal electrode opposing the other terminal electrode, the outer edge thereof rising toward the opposite side of the stack.

### CROSS-REFERENCE TO RELATED APPLICATIONS

This application claims the benefit of Japanese Application No. 2024-038072, filed Mar. 12, 2024, in the Japanese Patent Office. All disclosures of the document named above is incorporated herein by reference.

### 1. Field of the Invention

Aspects of the present invention relate to a multilayer ceramic capacitor and a circuit board.

### 2. Description of the Related Art

A wide variety of ceramic electronic components are used in high-frequency communication systems, such as in mobile phones. There is a demand for smaller and thinner ceramic electronic components, and multilayer ceramic capacitors are being considered to reduce the size and thickness of these components.

Patent Document 1 discloses a thin, damage-resistant multilayer ceramic capacitor in which via hole electrodes used to electrically connect the internal electrode layers and the terminal electrodes to each other have a void inside. In the multilayer ceramic capacitor disclosed in Patent Document 1, the terminal electrodes are formed on the top surface of the element body, which has a flat shape.

### PRIOR ART DOCUMENTS

### Patent Documents

Patent Document 1

JP 2020-72263 A

### Non-Patent Documents

Non-Patent Document 1

J. A. Ahmar et al., “Flex Cracking of Multilayer Ceramic Capacitors: Experiments on Fracture Propagation,” 2018 7th Electronic System Integration Technology Conference (ESTC), Dresden, Germany, 2018, pp. 1-6

### SUMMARY OF THE INVENTION

### Problem to Be Solved by the Invention

In multilayer ceramic capacitors, stress may be applied in a direction that separates the terminal electrodes from each other due to thermal shock caused by soldering when mounting the capacitor on a circuit board or due to deflection deformation of the circuit board after mounting. This stress may be concentrated at the end portions of the terminal electrodes and transferred to the element body, causing cracks, as reported in Non-Patent Document 1. Cracks thus formed in the element body often start at the terminal electrode end portions and develop toward the interior of the element body, causing short-circuit defects due to the concentration of electric fields in the air layer caused by cracks. Therefore, there is demand for multilayer ceramic capacitors that are resistant to cracking from the time of mounting on the circuit board through handling of the mounted circuit board to the time of use.

It is an object of the present invention to solve this problem by providing a multilayer ceramic capacitor that suppresses cracking during and after mounting on a circuit board, and a circuit board on which this multilayer ceramic capacitor has been mounted.

### Means for Solving the Problem

As a result of extensive research conducted to solve this problem, the present inventors discovered that this object could be achieved by making the mounting face of the multilayer ceramic capacitor, that is, the face opposing the circuit board when mounted on a circuit board, have sloped portions at the boundary with the terminal electrodes that rise to the top surface where the terminal electrodes are exposed. The present invention is a product of this discovery.

Specifically, a first aspect of the present invention that solves this problem is a multilayer ceramic capacitor, comprising: a cuboid element body having a stack formed with alternating ceramic layers and internal electrodes made primarily of metal and a protective portion covering a surface of the stack, and a plurality of terminal electrodes arranged on at least a mounting face, which is the face that faces the circuit board when the multilayer ceramic capacitor is mounted on the circuit board, among faces that form the surfaces of the element body, and connected electrically to the internal electrodes, wherein the mounting face has a sloped portion in the vicinity of the end portion of each terminal electrode opposing the other terminal electrode, the outer edge thereof rising toward the opposite side of the stack.

A second aspect of the present invention that solves this problem is a circuit board carrying the multilayer ceramic capacitor according to the first aspect.

### Effect of the Invention

Aspects of the present invention are able to provide a multilayer ceramic capacitor in which cracking is suppressed during and after mounting on a circuit board, as well as a circuit board carrying this multilayer ceramic capacitor.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram (perspective view) showing the configuration of the multilayer ceramic capacitor in the first embodiment of the present invention.

FIG. 2 is a cross-sectional view (LT cross-sectional view) from A-A in FIG. 1.

FIG. 3a is a schematic diagram (LT cross-sectional view) showing a straight sloped portion.

FIG. 3b is a schematic diagram (LT cross-sectional view) showing a curved sloped portion.

FIG. 4 is a diagram showing the process of checking for the presence of a sloped portion on the mounting face in a microscopic image.

FIG. 5 is a schematic diagram (LT cross-sectional view) showing a mounting face with protruding portions between the sloped portions.

FIG. 6 is a schematic diagram (LT cross-sectional view) showing the configuration of the multilayer ceramic capacitor in the second embodiment of the present invention.

FIG. 7 is a schematic diagram (perspective view) showing the configuration of the multilayer ceramic capacitor in the third embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

The configuration and effects of the present invention will now be explained with technical concepts and with reference to the drawings. The mechanism of action includes conjecture, but correctness or incorrectness of this conjecture does not limit the present invention.

### Multilayer Ceramic Capacitor

### First Embodiment

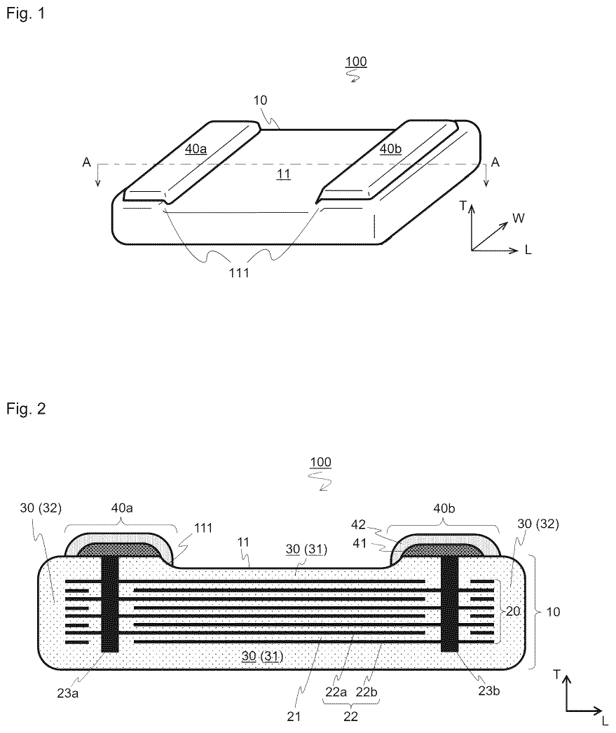

An embodiment of a multilayer ceramic capacitor related to the first aspect of the present invention is shown in FIG. 1 and FIG. 2 as the first embodiment. The multilayer ceramic capacitor 100 in the first embodiment has a cuboid shape and has a pair of planes that are orthogonal to each other on three mutually orthogonal axes, namely, the L-axis, which is the length direction, the W-axis, which is the width direction, and the T-axis, which is the height direction. The cuboid is not limited to a cuboid shape defined mathematically, but can be any shape that is recognized as being cuboid when the overall shape is observed. For this reason, objects with rounded edges and corners, curved edges, and surfaces with a small degree of curvature also fall under the category of “cuboid” in the present disclosure. The length (L), width (W), and height (T) dimensions of the ceramic capacitor 100 can each independently take any value.

In an example of dimensions for a multilayer ceramic capacitor 100, the L-direction dimension is 200 μm or more and 2000 μm or less, the W-direction dimension is 100 μm or more and 2000 μm or less, the T-direction dimension is 30 μm or more and 220 μm or less, and the W/L value, which is the ratio of the W-direction dimension to the L-direction dimension, is 0.3 or more and 1.0 or less. Preferably, the L-direction dimension is 400 μm or more and 1200 μm or less, the W-direction dimension is 400 μm or more and 1200 μm or less, the T-direction dimension is 40 μm or more and 150 μm or less, and the W/L value, which is the ratio of the W-direction dimension to the L-direction dimension, is 0.4 or more and 1.0 or less. A T-direction dimension of 100 μm or less is preferred in that it is less likely to impose design constraints on the circuit board on which it is mounted.

In the multilayer ceramic capacitor 100 of the first embodiment, as shown schematically in cross-sectional view in FIG. 2, the element body 10 has ceramic layers 21, internal electrodes 22 made primarily of metal, which are alternately stacked in the T direction to form a stack 20, and a protective portion 30 that covers the surfaces of the stack 20. The internal electrodes 22 include internal electrodes 22a of one polarity that are electrically connected to each other, and internal electrodes 22b of a different polarity than internal electrodes 22a that are electrically connected to each other.

There are no particular restrictions on the method used to electrically connect internal electrodes 22a to each other or internal electrodes 22b to each other. In FIG. 2, via conductors 23 (23a, 23b) pass through the ceramic layers 21 in the stacking direction of the stack 20, and at least one end is connected by way of via conductors 23 (23a, 23b) that reach the surface of the protective portion 30 (cover portion 31) described below. However, as in the second embodiment described below, the internal electrodes may be drawn out to the end face of the element body and connected by an external conductor. The multilayer ceramic capacitor 100 shown in FIG. 2 has two via conductors 23, but the number of via conductors in the multilayer ceramic capacitor in the first aspect of the present invention is not limited to this example.

On the surfaces of the element body 10, a protective portion 30 is arranged to cover the surfaces of the stack 20. The protective portion 30 includes a cover portion 31 arranged on a plane perpendicular to the T direction, and margin portions 32 arranged on planes perpendicular to the W and L directions.

In the multilayer ceramic capacitor 100 of the first embodiment, among the plurality of faces forming the surfaces of the element body 10, a plurality of terminal electrodes 40 (40a, 40b) are arranged on a mounting face 11, which is the face opposite to the circuit board when the multilayer ceramic capacitor is mounted on the circuit board, and are electrically connected to the internal electrodes 22 (22a, 22b). There are no particular restrictions on the method used to electrically connect the terminal electrodes 40 (40a, 40b) and internal electrodes 22 (22a, 22b). In FIG. 2, connections are by way of via conductors 23 (23a, 23b), but the connections may also be by way of an external conductor, as in the second embodiment described below. The multilayer ceramic capacitor 100 shown in FIG. 2 has two terminal electrodes 40, but the number of terminal electrodes in the multilayer ceramic capacitor of the first aspect of the present invention is not limited to this example.

The multilayer ceramic capacitor 100 of the first embodiment has a mounting face 11 with sloped portions 111 in which an outer edge rises toward the opposite side of the stack 20, in the vicinity of the end portion that opposes the other terminal electrode of the terminal electrodes 40 (40a, 40b).

The thickness of the element body 10, which is obtained by subtracting the thickness of the terminal electrodes 40 (40a, 40b) from the T-direction dimension of the multilayer ceramic capacitor 100, is, for example, 20 μm or more and 200 μm or less, and preferably 30 μm or more and 180 μm or less.

The following is a detailed description of each component that constitutes the multilayer ceramic capacitor 100 in the first embodiment.

### (Ceramic Layers)

The ceramic layers 21 are formed of a ceramic. The composition of the ceramic is not particularly limited, as long as it forms a dense ceramic layer 21 during simultaneous firing with the internal electrodes 22 described below, and can be selected as appropriate depending on the characteristics required of the multilayer ceramic capacitor. Examples of ceramic compositions include those with barium titanate (BaTiO₃) as the main component, those with strontium titanate (SrTiO₃) as the main component, and those with a perovskite-type structure Ba1-x-yCaₓ Sr_{y}Ti_{1-z}Zr₂O₃ as the main component. The ceramic may contain additive elements in addition to the main components mentioned above. Examples of additive elements include at least one selected from Mo, Nb, Ta, W, Mg, Mn, V, and Cr, rare earth elements (Y, Sm, Eu, Gd, Tb, Dy, Ho, Er, Tm, and Yb), and Co, Ni, Li, B, Na, K, and Si. The additive element may be included in the form of a compound, such as an oxide, nitride, or carbide, or it may be included as the element in its pure form. In addition, the additive elements may be present in a solid solution with the main component mentioned above, or may form a different phase with the element that constitutes the main component or another additive element.

### (Internal Electrodes)

The internal electrodes 22 (22a, 22b) are composed primarily of metal. There are no particular restrictions on the type of metal, and nickel (Ni), copper (Cu), palladium (Pd), platinum (Pt), silver (Ag), gold (Au), or alloys of these metals can be used. Among these, those with nickel (Ni) as the main component element are preferred because of their high heat resistance, which allows the firing temperature to be increased during firing together with the ceramic layers 21 to form dense ceramic layers 21, and because they are relatively inexpensive. In this document, the term “main component element” refers to the element with the highest content, expressed as an atomic percentage (at %).

In addition to metal, the internal electrodes 22 (22a, 22b) may also contain ceramic particles having a composition similar to that of the ceramic that constitutes the ceramic layers 21, or glass components.

### (Protective Portion)

The protective portion 30 has the function of protecting the ceramic layers 21 and internal electrodes 22. The material in the protective portion 30 is not limited as long as it has high electrical insulation properties and low permeability to moisture and other degradation factors. From the standpoint of ensuring uniform shrinkage during firing when manufacturing the multilayer ceramic capacitor 100, and relieving internal stress inside the multilayer ceramic capacitor 100, the main component of the protective portion 30 is preferably the same as the ceramic forming the ceramic layers 21.

### (Via Conductors)

Like the internal electrodes 22 (22a, 22b), the via conductors 23 (23a, 23b) are made primarily of metal. The metals that can be used are the same as those used in the internal electrodes 22 (22a, 22b) mentioned above. The composition of the via conductors may be different from that of the internal electrodes 22 (22a, 22b), but is preferably the same as that of the internal electrodes 22 (22a, 22b). By making the composition of the via conductors (23a, 23b) and the internal electrode 22 (22a, 22b) the same, the degree of shrinkage caused by firing during the manufacture of the multilayer ceramic capacitor 100 is uniform, which helps to suppress deformation, and the resistivity of the conductive paths of the multilayer ceramic capacitor 100 is uniform, which helps to suppress localized heat generation during use.

The diameter of the via conductors (23a, 23b) is not particularly limited, but from the standpoint of reducing electrical resistance and suppressing heat generation during circuit operation while maintaining the capacitance of the multilayer ceramic capacitor 100, the diameter is preferably 5 μm or more and 100 μm or less, and more preferably 10 μm or more and 50 μm or less.

### (Terminal Electrodes)

The material of the terminal electrodes 40 (40a, 40b) is not limited as long as the material has electrical conductivity. Examples of materials include metals such as nickel (Ni), copper (Cu), tin (Sn), palladium (Pd), platinum (Pt), silver (Ag), and gold (Au), alloys containing any of these as the main component, and electrically conductive resins.

The terminal electrodes 40 (40a, 40b) may be composed of a base conductor 41 in contact with the element body 10 and a plated conductor 42 formed on the surface of the base conductor 41. Terminal electrodes 40 (40a, 40b) with this structure can improve adhesion of the element body 10 with the base conductor 41, and improve the solder wettability when mounted on the circuit board using the plated conductor 42.

An example of a material for the base conductor 41 is Ni. The thickness of the base conductor 41 can be 0.1 μm or more and 10 μm or less, and is preferably 0.5 μm or more and 5μm or less. The base conductor 41 is preferably arranged at a distance of 15 μm or more from the outer edge of the mounting face 11, so that the plated conductor 42 can be formed with sufficient thickness while maintaining the distance between the terminal electrodes 40 (40a, 40b) and the outer edge of the mounting face 11.

The plated conductor 42 may be formed with a single layer or with multiple layers. When multiple layers are formed in the plated conductor 42, two to four layers is preferred. In one example of the materials and structure of the plated conductor 42, a structure is formed in the order Cu, Ni, and Sn. The thickness of the plated conductor 42 can be 1 μm or more and 20 μm or less, and 3 μm or more and 10 μm or less is preferred.

The area of the terminal electrodes 40 (40a, 40b), that is, the area of the terminal electrodes 40 (40a, 40b) when the multilayer ceramic capacitor 100 is viewed from a direction perpendicular to the mounting face, is not particularly limited, but it should be large enough to enable easy mounting on a circuit board and small enough that electrodes with different polarities do not short-circuit. Preferably, the ratio of the total area of the terminal electrodes 40 to the area of the mounting face 11 is 0.2 or more and 0.9 or less, and more preferably 0.3 or more and 0.8 or less.

### (Sloped Portions)

On the mounting face 11, the slope portions 111, which are formed so that the outer edge rises up on the side opposite to the stack 20, are arranged in the vicinity of the end portions in the terminal electrodes 40 (40a, 40b) that oppose the other terminal electrode. Due to the presence of the sloped portions 111, the thickness (T-direction dimension) of the element body 10 smoothly decreases from the outer edge to the center of the mounting face 11. Due to this decrease in thickness, when tensile stress occurs between terminal electrodes 40 (40a, 40b), the stress that is transmitted to the element body is applied not only to the edges of terminal electrodes 40 (40a, 40b) on the mounting face 11, but also to the thinner central portion, resulting in the concentration of stress being alleviated and the appearance of cracks being suppressed.

In this document, the expression “in the vicinity of” the end portions of the terminal electrodes refers to the region in which the stress-relieving action described above is exerted. Specifically, this region is within 50 um of the terminal electrode end portion.

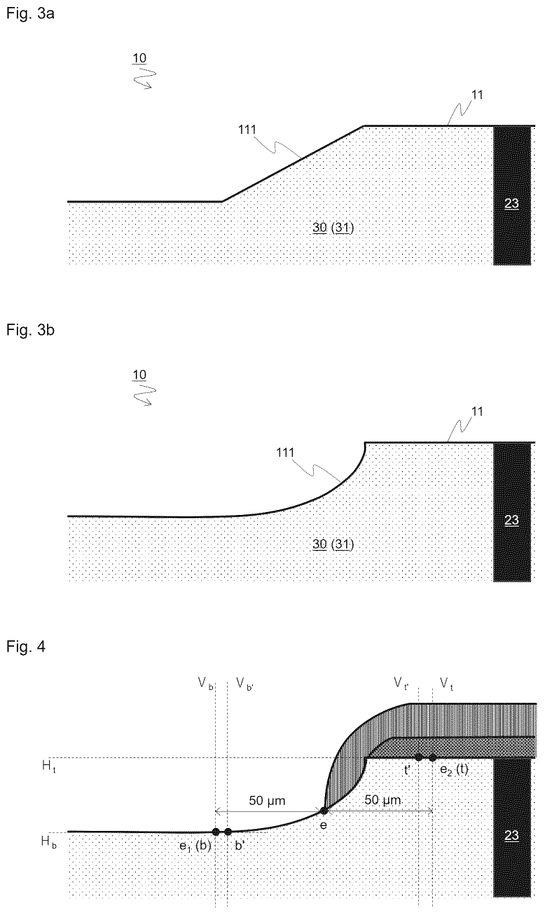

In the present specification, the term “sloped portion” refers to a portion that has a shape in which the height (position in the T direction) changes smoothly in response to changes in position within the mounting face 11, and is distinguished from a shape in which the height changes suddenly, such as a “step”. The shape of the cross-section of the sloped portion 111 parallel to the stacking direction of the stack 20 may be straight, as shown in FIG. 3a, or curved, as shown in FIG. 3b. A shape for the sloped portion 111, in which the slope increases as it approaches the top, is preferred because it increases the stress-relieving action described above. Preferably, the rising height of the sloped portion 111, hₛ, satisfies 0.1 μm≤hₛ≤10 μm. Also, the length lₛ of the sloped portion 111, when projected onto a plane perpendicular to the stacking direction of the stack 20, satisfies 1 μm≤lₛ≤100 μm. The stress-relieving effect described above is particularly pronounced when the rising height (hₛ) and the length (lₛ) are within the ranges described above.

The following process is used to determine whether the mounting face 11 has sloped portions 111 near the end portions of the terminal electrodes 40 (40a, 40b) that oppose the other terminal electrode. First, the multilayer ceramic capacitor 100 is cut along a plane parallel to the stacking direction through multiple terminal electrodes 40 formed on the mounting face 11 opposite each other to obtain an inspection sample. This inspection sample may be prepared by polishing the surface perpendicular to the mounting face until multiple terminal electrodes 40 that are opposite each other on the mounting face 11 have been reached. The inspection sample is then embedded in resin so that the cut surface is exposed, and the cut surface is polished to a mirror finish. Next, the mirror-polished cut surface is inspected using an optical microscope or scanning electron microscope (SEM), and an image is obtained in which at least one terminal electrode 40 and a part of the mounting face 11 positioning between the terminal electrode 40 and the other terminal electrode oppose to the terminal electrode 40 are in the same field of view, as shown in FIG. 4. The inspection magnification factor at this time should be sufficient to allow the shape of the mounting face 11 in the vicinity of the end portion of the terminal electrode 40 to be grasped. Examples of magnification factors include 2000x to 10000x. Next, in the acquired image, the intersection e between the end portion of the terminal electrode 40 that opposes the other terminal electrode and the mounting face 11 is determined, and a line segment is drawn from point e that is perpendicular to the horizontal direction of the mounting face 11 and that passes through two points that are 50 μm apart in actual size. The intersection points of the line segments and the mounting face 11 are denoted by e₁ and e₂. Given the possibility that a sloped portion 111 is present in the vicinity of point e, the horizontal direction of the mounting face 11 at this time is determined based on the shape of the mounting face 11 directly below a terminal electrode 40 that is located sufficiently far from point e (for example, a position with a distance of 60 μm or more from point e). Next, in the acquired image, a line segment H_{b} that passes through the lowest point (the point that is located at the lowest point in the image) on the mounting face 11 located between points e₁ and e₂ and is horizontal to the mounting face 11, and a line segment Hₜ that passes through the highest point (the point that is located at the highest point in the image) and is horizontal to the mounting face 11 are drawn. The intersection points of each line segment and the mounting face 11 are points b and t, respectively. Depending on the shape of the mounting face 11, as shown in FIG. 4, point b may coincide with the point e₁, or point t may coincide with point e₂. In this case, one point is considered to have both meanings. Next, it is determined that the sloped portion 111 is located in the vicinity of the end portion of the terminal electrode 40 that faces the other terminal electrode, based on the mounting face 11 in the image rising smoothly from point b to point t without any steps.

At this time, the distance between line segment H_{b} and line segment Hₜ is defined as the rising height hₛ of the rise of the sloped portion 111, and the distance between line segment V_{b} passing through point b and perpendicular to mounting face 11 and line segment Vₜ passing through point t and perpendicular to mounting face 11 is the length lₛ of the sloped portion 111 projected onto a plane perpendicular to the stacking direction of the stack 20. Note that the height hₛ of the sloped portion 111 may be determined simply by measuring the thickness of the portion of the element body 10 that is in contact with the terminal electrode 40 and the thickness of the portion that is not in contact with the terminal electrode 40, and taking the difference between them.

The determination of whether the slope of a sloped portion 111, which was determined to be located in the vicinity of the end portion of a terminal electrode 40 opposite the other terminal electrode in the process described above, increases as it approaches the top, is performed using the following process. First, perpendicular line segment V_{b′} is drawn at a distance of lₛ/10 from line segment V_{b} to line segment Vₜ, and the intersection point with the mounting face 11 is denoted by b′. Then, perpendicular line segment V_{t′} is drawn at a distance of lₛ/10 from perpendicular line segment Vₜ to perpendicular line segment V_{b}, and the intersection point with the mounting face 11 is denoted by t′. Next, the shape of the mounting face 11 located between point b and point b′ and the shape of the mounting face 11 located between point t and point t′ are linearly approximated to obtain line segments. When the slope of the line segment obtained from the shape of the mounting face 11 located between point t and point t′ is greater than the line segment obtained from the shape of the mounting face 11 located between point b and point b′, the slope of the sloped portion 111 is determined to increase as it approaches the top.

Preferably, the sloped portions 111 do not make contact with the base conductor 41 if the terminal electrodes 40 (40a, 40b) have a base conductor 41 and a plated conductor 42. The base conductor 41 is often formed by integral firing with the element body 10, in which the metal element forming the base conductor 41 diffuses into the cover portion 31 via the mounting face 11 during firing. In the sloped portions 11, the thickness of the cover portion 31 is thinner, so if diffusion of the metal element occurs from the contact with the base conductor 41, a decrease in insulation due to the metal element reaching the internal electrodes 22 (22a, 22b) is likely to occur. Therefore, by avoiding contact of the base conductors 41 with the sloped portions 111, deterioration in the insulating properties of the multilayer ceramic capacitor 100 can be suppressed.

If the sloped portions 111 are not in contact with the base conductors 41, the plated conductors 42 are preferably arranged on top of the sloped portions 111. This increases the contact area between the sloped portions 111 and the plated conductors, thereby increasing the bonding strength.

### (Shape of the Mounting Face Beyond the Sloped Portions)

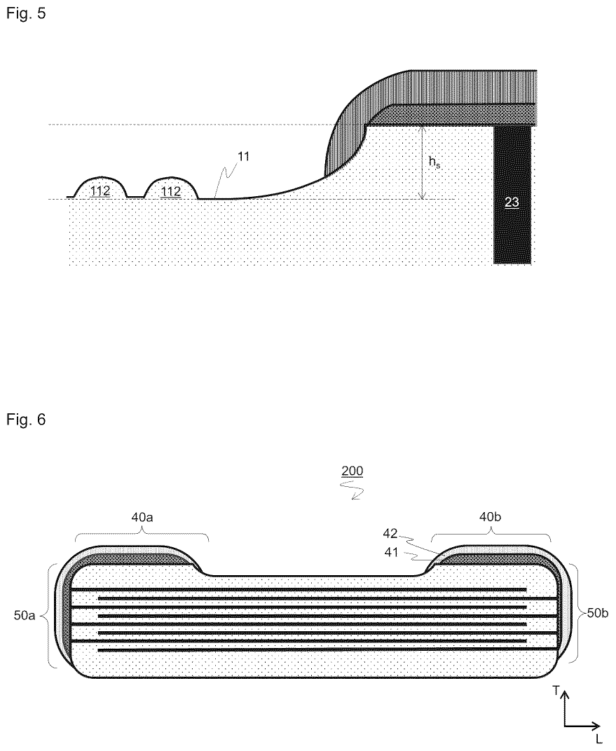

As shown in FIG. 5, the mounting face 11 preferably has protruding portions 112 between sloped portions 111 with a height of between 0.2 hₛ and 0.9 hₛ, where the rising height is hₛ. This increases the bonding area between the mounting face 11 and the resin when the multilayer ceramic capacitor 100 is resin-embedded during mounting on a circuit board, thereby increasing the bonding strength.

### Second Embodiment

Another embodiment (second embodiment) of the multilayer ceramic capacitor in the first aspect of the invention is one in which the internal electrodes are electrically connected to each other by way of external conductors. An example of the multilayer ceramic capacitor 200 in the second embodiment is shown in FIG. 6. In the multilayer ceramic capacitor 200, the internal electrodes drawn on the end faces of the element body 10 are electrically connected to each other by external conductors 50 (50a, 50b), and the external conductors 50 (50a, 50b) are electrically connected to the terminal electrodes 40 (40a, 40b) located on the mounting face 11. While FIG. 6 shows an example in which the external conductors 50 (50a, 50b) are formed on a pair of end faces opposing each other, the external conductors may be formed on only one end face.

### Third Embodiment

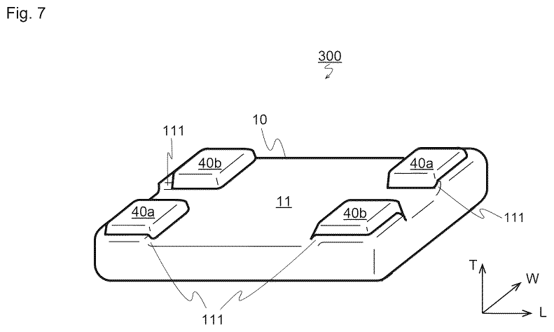

In another embodiment (the third embodiment) of the multilayer ceramic capacitor in the first aspect of the present invention, the number of terminal electrodes arranged on the mounting face is four or more, and each terminal electrode has a different polarity from the other terminal electrodes with which it is in close proximity on the mounting face. An example of the third embodiment of the multilayer ceramic capacitor 300 is shown in FIG. 7. While FIG. 7 shows an example in which the number of terminal electrodes 40 arranged on the mounting face 11 is 4, the number of terminal electrodes arranged on the mounting face is not limited to this example. Because the multilayer ceramic capacitor 300 is configured so that the direction of the current flowing through the via conductors 23 (23a, 23b) electrically connected to each terminal electrode 40 (40a, 40b) is opposite between conductors 23 (23a, 23b) that are in closest proximity to each other, the magnetic fields generated by the currents cancel each other out and reduce ESL. The ESL reducing effect is more pronounced when the multilayer ceramic capacitor 300 has a mounting face 11 that is nearly square in shape, that is, when the value of W/L, which is the ratio of W to L, is between 0.8 and 1, where, among the two faces parallel to the stacking direction of the stack and facing each other, one spacing, or dimension in the L direction, is L μm, and the other spacing, or dimension in the W direction, is W μm (provided L≥W).

### [Method for Manufacturing Multilayer Ceramic Capacitor]

A multilayer ceramic capacitor in the first aspect of the present invention can be manufactured by the procedure described below.

### ((A) Preparation of Ceramic Powder)

First, the ceramic powder is prepared. Commercially available ceramic powders can be used if appropriate. When the ceramic powder is prepared by the user, raw powder materials including their constituent elements are mixed at a predetermined ratio and pre-fired (provisionally fired). Additives such as the additive elements and firing aids may be added when mixing the raw powder materials at predetermined ratios, or the additives may be added to the powder after provisional firing.

((B) Preparation of the Green Sheet) Next, the ceramic powder is mixed with a binder and dispersant to prepare a slurry, which is then formed into a sheet to obtain a green sheet.

The binder used should be one that can maintain the shape of the green sheet, and that can volatilize without leaving behind carbon or other residues in the binder removal step prior to firing. Examples of binders that can be used include polyvinyl alcohol-based, polyvinyl butyral-based, cellulose-based, urethane-based, and vinyl acetate-based binders. The amount of binder used is not limited, but since it is removed in a subsequent step, the amount of binder used is preferably minimized to the extent that the desired moldability and shape retention can be obtained, in order to reduce raw material costs.

The dispersant used should be one that can keep the previously fired powder and the binder from agglomerating and should be easily removed by volatilization or other means after formation of the green sheet described below. Examples of dispersants that can be used include water and alcohol-based solvents.

Components that adjust the properties of the slurry, such as dispersants, plasticizers, and thickeners, may be added to the slurry.

The method used to mix the mixed powder with the binder and dispersant is not limited as long as each component is uniformly mixed and impurities are kept from being mixed in. One example is ball mill mixing.

Methods that can be used to form the prepared slurry into a sheet to obtain a green sheet include any method common in the art, such as the doctor blade method and the die coating method.

### ((C) Formation of the Internal Electrode Pattern)

Next, an internal electrode pattern containing metal is formed on the green sheet. The internal electrode pattern can be formed by printing or coating internal electrode paste in a predetermined pattern, or by forming a metal film in a predetermined pattern by vapor deposition or sputtering deposition. The internal electrode pattern should be formed leaving a sufficient margin to ensure electrical insulation where there is no contact with the via conductor pattern formed later.

When forming an internal electrode pattern using an internal electrode paste, the internal electrode paste is obtained by mixing metal particles with a vehicle in a three-roll mill. In addition to the components mentioned above, the internal electrode paste may also contain glass frit or ceramic powder.

The type and amount of binder and solvent included in the vehicle are not limited, and are preferably selected as appropriate after taking into consideration the viscosity of the internal electrode paste, ease of handling, and compatibility with the green sheet.

Printing of the internal electrode paste on the raw sheet can be performed, for example, using a screen mask with a predetermined internal electrode pattern. During printing, a space, that will become the margin portion when made into a multilayer ceramic capacitor, can be left.

### ((D) Preparation of the Green Stack)

Next, green sheets with internal electrode patterns are stacked in a predetermined number of layers, and the green sheets are pressure-bonded to obtain a green stack. Stacking and pressure bonding can be performed using any method common in the art, such as pressing the stacked green sheets together in the stacking direction while heating, and thermo-compression bonding the green sheets together by the action of the binder. At this time, a mold with a convex surface may be pressed against the green sheet to form recessed portions on the face that will become the mounting face, thereby forming sloped portions that rise from the recessed portion.

When performing stacking and pressure bonding, a green sheet may be added to the end in the stacking direction to serve as a cover portion when made into a multilayer ceramic capacitor. At this time, the green sheet that is added may have the same or a different composition from the green sheets on which an internal electrode pattern has been printed. From the standpoint of matching the shrinkage rate during firing, the composition of the green sheet that is added is preferably the same or similar to the composition of the green sheets on which the internal electrode precursors have been arranged.

### ((E) Formation of the Via Conductor Pattern)

When manufacturing the multilayer ceramic capacitor in the first embodiment, holes are formed in the green stack, and the holes are filled with conductive paste to form a via conductor pattern. A method common in the art such as a drill or laser can be used to form the holes. Among these, the use of a laser is preferred because of its ability to form smooth machined surfaces. A method common in the art such as injection with a syringe or printing with a metal mask can be used to fill the holes with conductor paste. Among these, printing with a metal mask is preferred because of its superiority in filling small-diameter holes. As for the components in the conductor paste, the same as those in the internal electrode paste can be used, and the amount of each component should be determined after taking into consideration the hole filling properties.

### ((F) Formation of the Terminal Electrode Pattern)

Next, a terminal electrode pattern is formed on at least one of the faces (mounting face) perpendicular to the stacking direction of the green stack. At this time, a green sheet that will become the cover portion when the multilayer ceramic capacitor is formed is pressure bonded to cover the via conductor pattern on the face without the terminal electrode pattern. The terminal electrode pattern can be formed by printing or applying terminal electrode paste or by forming a metal film by vapor deposition or sputtering deposition. The terminal electrode pattern may be formed using a mask with a predetermined pattern or may be formed out of a paste film or metal film on the entire mounting face of the green stack by removing the portions outside of the terminal electrode pattern. Face milling, barrel polishing, and laser machining can be employed to remove the portions outside of the terminal electrode pattern. When removing the portions outside of the terminal electrode pattern, portions of the surface of the green stack can also be removed to form sloped portions. When terminal electrode paste is used to form a terminal electrode pattern, the same components in the internal electrode paste described above can be used, and the amount of each compound should be determined so that a uniform pattern can be obtained with a predetermined thickness.

### ((G) Preparing Pre-Fired Chips)

Next, the green stack is separated into units in the shape of individual multilayer ceramic capacitors to obtain chips prior to firing. Means commonly used to separate a green stack into individual capacitors include dicing saws and laser cutting machines. After the green stack has been separated into units to form a face on which the internal electrode precursor is exposed, the face may be coated with a material for forming a margin portion to complete the pre-fired chips.

### ((H) Removing the Binder)

The resulting pre-fired chips are then heated to volatilize and remove the binder. Heating conditions should be set as appropriate after taking into consideration the amount and volatilization temperature of the binder. One example is to hold temperatures from 200°° C. to 500° C. for 5 to 20 hours in a nitrogen (N₂) atmosphere.

### ((I) Firing the Pre-Fired Chips)

Next, the pre-fired chips with the binder removed are heated to a predetermined temperature for firing. When setting the firing conditions, the firing properties of the ceramic powder and the heat and oxidation resistance of the metals in the internal electrode pattern, via conductor pattern, and terminal electrode pattern are preferably taken into consideration. Examples of firing conditions include holding the chips at 1100° C. to 1400° C. for 10 minutes to 2 hours in a reducing atmosphere of nitrogen (N₂), hydrogen (H₂), and water vapor (H₂O). After firing, re-oxidation treatment may be performed in a nitrogen (N2) gas atmosphere or in a low-oxygen atmosphere kept at 600° C. to 1000° C.

### ((J) Formation of Outer Conductors and Terminal Electrodes)

When manufacturing the multilayer ceramic capacitor in the second embodiment, either (E) is not performed and external conductors are formed following (I), or (E) and (F) are not performed and external conductors and terminal electrodes are formed following (I). Examples of methods that can be used to form external conductors and terminal electrodes include firing conductive paste applied by printing or dipping, and forming metal film by physical vapor deposition (PVD) such as vacuum deposition.

The fired body thus obtained may be used as a multilayer ceramic capacitor as is, or it may be used as a multilayer ceramic capacitor after a conductive layer has been formed on the surface of the terminal electrode pattern by plating.

### [Circuit Board]

The circuit board in the second aspect of the invention has a mounted multilayer ceramic capacitor in the first aspect. This circuit board has excellent durability because the multilayer ceramic capacitor suppresses the occurrence of cracks.

The following technologies are also disclosed in the present specification.

### (Addendum 1)

A multilayer ceramic capacitor, comprising:
a cuboid element body having
   a stack formed with alternating ceramic layers and internal electrodes made primarily of metal and
   a protective portion covering a surface of the stack, and
a plurality of terminal electrodes arranged on at least a mounting face, which is the face that faces the circuit board when the multilayer ceramic capacitor is mounted on the circuit board, among faces that form the surfaces of the element body, and connected electrically to the internal electrodes,

wherein the mounting face has a sloped portion in the vicinity of the end portion of each terminal electrode opposing the other terminal electrode, the outer edge thereof rising toward the opposite side of the stack. (Addendum 2)

The multilayer ceramic capacitor according to (Addendum 1), wherein the plurality of terminal electrodes have a base conductor contacting the element body and a plated conductor formed on the surface of the base conductor, and the base conductor does not make contact with the sloped portions.

### (Addendum 3)

The multilayer ceramic capacitor according to (Addendum 2), wherein the plated conductor is arranged on the sloped portions.

### (Addendum 4)

The multilayer ceramic capacitor according to any of (Addendum 1) to (Addendum 3), wherein the slope of the sloped portions becomes steeper closer to the top of the sloped portions.

### (Addendum 5)

The multilayer ceramic capacitor according to any of (Addendum 1) to (Addendum 4), wherein the rising height hₛ of the sloped portions satisfies 0.1 μm≤hₛ≤10 μm.

### (Addendum 6)

The multilayer ceramic capacitor according to any of (Addendum 1) to (Addendum 5), wherein the length lₛ of the sloped portions projected onto a plane perpendicular to the stacking direction of the stack satisfies 1 μm≤lₛ≤100 μm.

### (Addendum 7)

The multilayer ceramic capacitor according to any of (Addendum 1) to (Addendum 6), wherein the mounting face has a protruding portion with a height of 0.2 hₛ or more and 0.9 hₛ or less between the slope portions, where the height of the rise in the sloped portions is hₛ.

### (Addendum 8)

The multilayer ceramic capacitor according to any of (Addendum 1) to (Addendum 7), wherein the number of terminal electrodes is four or more, and each of the terminal electrodes has a polarity that differs from that of the terminal electrode closest thereto on the mounting face.

### (Addendum 9)

The multilayer ceramic capacitor according to any of (Addendum 1) to (Addendum 8), wherein an electrode is not arranged on the opposite face, which is the face opposing the mounting face, among the faces that form the surfaces of the element body, and the height, which is the dimension in the direction orthogonal to the region on the mounting face excluding the sloped portions, is 100 μm or less.

### (Addendum 10)

A circuit board carrying the multilayer ceramic capacitor according to any one of (Addendum 1) to (Addendum 9).

### INDUSTRIAL APPLICABILITY

Aspects of the present invention are able to provide a multilayer ceramic capacitor in which cracking is suppressed during and after mounting on a circuit board, as well as a circuit board carrying this multilayer ceramic capacitor. Such multilayer ceramic capacitors and circuit components are useful because they are highly durable.

Although a few embodiments of the present invention have been shown and described, it would be appreciated by those skilled in the art that changes may be made in this embodiment without departing from the principles and spirit of the invention, the scope of which is defined in the claims and their equivalents.

### KEY TO THE DRAWINGS

100, 200, 300: Multilayer ceramic capacitor
10: Element body
11: Mounting face
111: Sloped portion
112: Protruding portion
20: Stack
21: Ceramic layer
22: (22a, 22b): Internal electrodes
23: (23a, 23b): Via conductors
30: Protective portion
31: Cover portion
32: Margin portion
40: (40a, 40b): Terminal electrodes
50: (50a, 50b): Outer conductors
41: Base conductor
42: Plated conductor

What is claimed is:

1. A multilayer ceramic capacitor, comprising:
a cuboid element body having
a stack formed with alternating ceramic layers and internal electrodes made primarily of metal and
a protective portion covering a surface of the stack, and
a plurality of terminal electrodes arranged on at least a mounting face, which is the face that faces the circuit board when the multilayer ceramic capacitor is mounted on the circuit board, among faces that form the surfaces of the element body, and connected electrically to the internal electrodes,
wherein the mounting face has a sloped portion in the vicinity of the end portion of each terminal electrode opposing the other terminal electrode, the outer edge thereof rising toward the opposite side of the stack.

2. The multilayer ceramic capacitor according to claim 1, wherein the plurality of terminal electrodes have a base conductor contacting the element body and a plated conductor formed on the surface of the base conductor, and the base conductor does not make contact with the sloped portions.

3. The multilayer ceramic capacitor according to claim 2, wherein the plated conductor is arranged on the sloped portions.

4. The multilayer ceramic capacitor according to claim 1, wherein the slope of the sloped portions becomes steeper closer to the top of the sloped portions.

5. The multilayer ceramic capacitor according to claim 1, wherein the height hₛ of the rise in the sloped portions satisfies 0.1 μm≤hₛ≤10 μm.

6. The multilayer ceramic capacitor according to claim 1, wherein the length lₛ of the sloped portions projected onto a plane perpendicular to the stacking direction of the stack satisfies 1 μm≤lₛ≤100 μm.

7. The multilayer ceramic capacitor according to claim 1, wherein the mounting face has a protruding portion with a height of 0.2 hₛ or more and 0.9 hₛ or less between the slope portions, where the height of the rise in the sloped portions is hₛ.

8. The multilayer ceramic capacitor according to claim 1, wherein the number of terminal electrodes is four or more, and each of the terminal electrodes has a polarity that differs from that of the terminal electrode closest thereto on the mounting face.

9. The multilayer ceramic capacitor according to claim 1, wherein an electrode is not arranged on the opposite face, which is the face opposing the mounting face, among the faces that form the surfaces of the element body, and the height, which is the dimension in the direction orthogonal to the region on the mounting face excluding the sloped portions, is 100 μm or less.

10. A circuit board carrying the multilayer ceramic capacitor according to claim 1.
